(19) United States
(12) Patent Application Publication
(10) Pub. No.: US 2017/0357005 A1
(43) Pub. Date: Dec. 14, 2017

(54) GLOBAL NAVIGATION SATELLITE SIGNAL CATEGORIZATION

(71) Applicant: Apple Inc., Cupertino, CA (US)

(72) Inventors: Jonathan M. Diamond, San Francisco, CA (US); Glenn Donald MacGougan, San Jose, CA (US); Kumar Gaurav Chhokra, San Jose, CA (US); Robert Mayor, Half Moon Bay, CA (US); Yishuang Geng, Worcester, MA (US)

(73) Assignee: Apple Inc., Cupertino, CA (US)

(21) Appl. No.: 15/275,299

(22) Filed: Sep. 23, 2016

Related U.S. Application Data
(60) Provisional application No. 62/348,809, filed on Jun. 10, 2016.

(51) Int. Cl. G01S 19/10; G01S 19/42; G01S 19/21

(52) U.S. Cl. CPC G01S 19/10; G01S 19/21; G01S 19/42

(57) ABSTRACT

Techniques for improving positioning performance using categorization of navigation signal environment are described. A mobile device can receive signal environment data. The signal environment data can represent multiple geographic areas. The signal environment data includes a respective signal environment category for each geographic area, each signal environment category corresponding to a degree to which geographic features in the respective geographic area affect reception of the navigation signals. The mobile device can determine that the mobile device is located in a particular geographic area represented in the signal environment data. The mobile device can then select a set of one or more rules for aiding location estimation. The set of one or more rules can correspond to the signal environment category of the geographic area. The mobile device can estimate a location of the mobile device using the navigation signals and under the set of one more rules.

### CROSS-REFERENCE TO RELATED APPLICATION

This application claims priority to U.S. Provisional Patent Application No. 62/348,809, filed Jun. 10, 2016, the entire contents of which are incorporated herein by reference.

### TECHNICAL FIELD

This disclosure relates generally to location estimation using radio frequency signals.

### BACKGROUND

Many navigation devices use global navigation satellite system (GNSS) technology. In GNSS navigation, a device determines position, velocity, and time (PVT) based on signals received from GNSS satellites. GNSS satellite signals may be subject to interference. For example, GNSS satellite signals may be blocked or reflected before reaching a GNSS receiver of the device, causing positioning errors. To correct or reduce the positioning errors, a device can use auxiliary navigation systems. For example, a smartphone or wearable device equipped with a GNSS chip can have components that are configured to estimate a location using wireless signals, cellular signals, or inertial navigation technology. The output of one or more of these modules can compensate GNSS positioning errors when the smartphone or wearable device is located in a harsh GNSS environment where GNSS signals are non-existent, weak, or subject to multipath effect. Improvement in location estimate by using these modules may consume battery power, because each of these modules will require power to operate.

### SUMMARY

Techniques for improving positioning performance using categorization of navigation signal environment are described. A mobile device can receive signal environment data. The signal environment data can represent multiple geographic areas. The signal environment data can include a respective signal environment category for each geographic area. Each signal environment category can correspond to a degree to which geographic features in the respective geographic area affect reception of the navigation signals. The mobile device can determine that the mobile device is located in a particular geographic area represented in the signal environment data. The mobile device can then select a set of one or more rules for aiding location estimation. The set of one or more rules can correspond to the signal environment category of the geographic area. The mobile device can estimate a location of the mobile device using the navigation signals and under the set of one more rules.

The features described in this specification can be implemented to achieve various advantages. For example, a mobile device implementing the techniques can reduce positioning errors in challenging GNSS signal environments including urban canyons. When in such environments, the mobile device can automatically activate one or more modules or functions that can aid GNSS positioning and improve positioning accuracy. When a mobile device moves away from such environments, e.g., by moving to a rural area, the mobile device can automatically deactivate the modules or functions. Accordingly, the mobile device can avoid or reduce power consumption by deactivating unneeded components, thus prolonging battery life.

The details of one or more implementations of the techniques are set forth in the accompanying drawings and the description below. Other features, aspects and advantages of the subject matter will become apparent from the description, the drawings and the claims.

### BRIEF DESCRIPTION OF THE DRAWINGS

FIG. 1 is a diagram illustrating example signal environment data specifying signal environment categories.

FIG. 2 is a diagram illustrating example techniques of using signal environment data to aid location estimation.

FIG. 3 is a block diagram illustrating components of an example mobile device configured to use using signal environment data to aid positioning.

FIG. 4 is a block diagram illustrating components of an example location server providing signal environment data.

FIG. 5 is a flowchart of an example process of location estimation using signal environment data.

FIG. 6 is a block diagram illustrating an example device architecture of a mobile device implementing the features and operations described in reference to FIGS. 1-5.

FIG. 7 is a block diagram of an example network operating environment for the mobile devices of FIGS. 1-6.

FIG. 8 is a block diagram of a system architecture for an example location server.

Like reference symbols in the various drawings indicate like elements.

### DETAILED DESCRIPTION

### Example GNSS Signal Environment Data

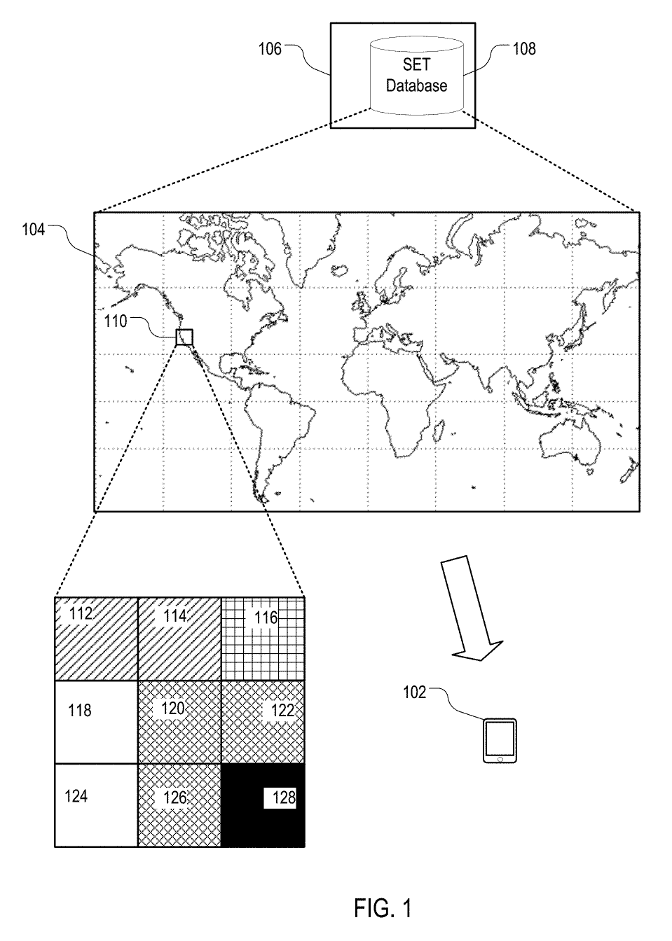

FIG. 1 is a diagram illustrating example signal environment data specifying signal environment categories. Mobile device 102 is a device configured to provide navigation services based on input from position, velocity and time (PVT) solutions of a GNSS navigation subsystem. Mobile device 102 can use signal environment data 104 to aid positioning. Signal environment data 104 can indicate a category of a GNSS signal environment in which mobile device 102 is located.

Mobile device 102 can obtain signal environment data 104 from location server 106. Location server 106 can include one or more computers configured to receive requests from, and provide data to, mobile device 102 through a communications network (e.g., the Internet).

Location server 106 can include signal environment tile database 108. Signal environment tile (SET) database 108 can store signal environment data 104 including GNSS signal environment data for a geographic area. The geographic area can be global. In some implementations, polar areas (e.g., latitude north of 80 degrees or south of 80 degrees) are excluded. Location server 106 can organize the information as signal environment tiles. Each signal environment tile can correspond to a portion of geographic area defined by latitude and longitude coordinates. Each signal environment tile can be, for example, a triangular, rectangular, hexagonal, trapezoidal, circular or elliptical geographic area or a geographical area having another geometric shape.

In the example shown, location server 106 can represent a portion 110 of the global geographic area as signal environment tiles 112, 114, 116, 118, 120, 122, 124, 126 and 128. Each of the tiles can be an M-by-N degree (e.g., 0.05 degrees latitude by 0.05 degrees longitude) geometric shape approximating a rectangle (not drawn to scale). Each geometric shape can cover a corresponding geographic area on Earth.

Each of the tiles can be associated with a signal environment category corresponding a respective degree, and optionally a type, of signal interference that may affect GNSS reception. The degree can correspond to an amount of interference, where a higher degree of signal interference corresponds to more interference. The type can indicate whether the interference is from reflection, blocking, or both. For example, signal environment tiles 118 and 124 can be associated with a first signal environment category (e.g., “marine”) indicating that reflection of GNSS signals will most likely be weak and be caused by bodies of water in the corresponding regions. Signal environment tiles 112 and 114 can be associated with a second category (e.g., “rural”) indicating that reflection of GNSS signals will most likely be weak and be caused by ground and isolated buildings in the corresponding regions. Signal environment tile 116 can be associated with a third category (e.g., “urban”) indicating that reflection of GNSS signals will be moderate and most likely be caused by sparsely distributed buildings in the corresponding region. Signal environment tiles 120, 122 and 126 can be associated with a fourth category (e.g., “dense urban”) indicating that reflection of GNSS signals will be strong and most likely be caused by connected or densely distributed buildings in the corresponding regions. Signal environment tile 128 can be associated with a fifth category (e.g., “urban canyon”) indicating that reflection of GNSS signals will be severe and most likely be caused by multiple tall buildings having mirror-like surfaces in the corresponding tile.

Each signal environment category may correspond to a set of one or more rules on how to aid the GNSS navigation subsystem to estimate PVT solutions, or how to improve accuracy of estimated PVT solutions and other modules of mobile device 102. Some signal environment categories can correspond to additional data that can aid a GNSS navigation subsystem to determine PVT solutions. For example, signal environment tile 128, being associated with an “urban canyon” environment category, can further be associated with detailed terrain data include locations, footprints, and heights of buildings, billboards, bridges and other structures in a corresponding geographic region.

The signal environment categories can be represented by an enumerated (e.g., “enum”) data type. In some implementations, location server 106 can provide signal environment data 104 to mobile device 102 as part of an application initialization process, when mobile device 102 configures a location-based application the first time. Subsequently, location server 106 can provide signal environment data 104 to mobile device 102 periodically to update the signal environment categories. In some implementations, location server 106 can provide signal environment data 104 to mobile device 102 upon request or in response to a trigger event.

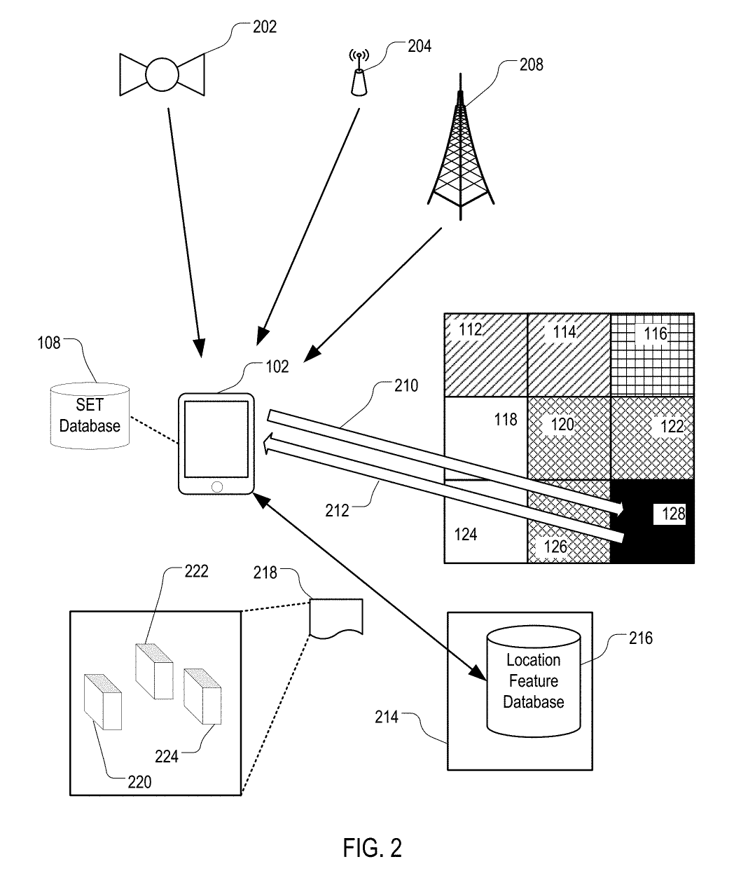

FIG. 2 is a diagram illustrating example techniques of using signal environment data to aid location estimation. Mobile device 102 can estimate an initial location, and use the estimated initial location to identify a signal environment category.

Mobile device 102 can estimate the initial location using various techniques. For example, mobile device 102 can estimate the initial location using signals from GNSS satellites 202, one or more wireless access points 204, one or more cell towers 208 or one or more location beacons. Mobile device 102 can estimate the initial location using an inertial navigation subsystem (e.g., by using dead reckoning). Mobile device 102 can estimate the initial location using user input. The initial estimated location may have a low accuracy level, corresponding to an error margin too large for accurate navigation. For example, a location estimated using cellular signals or with less than three satellites or poor satellite geometry (dilution of precision) obtained in an initial GNSS satellite scan can have an error margin of hundreds of meters.

Upon estimating the initial location, mobile device 102 can use that initial estimated location to query a database storing signal environment data 104 (e.g., database 108 of FIG. 1). Database 108 can be local to the mobile device 102 and pre-populated with signal environment data 104 as described in reference to FIG. 1. Mobile device 102 can identify a signal environment tile that matches (e.g., encloses) the initial estimated location. In the example shown, query 210 includes geographic coordinates of the initial estimated location. Mobile device 102 determines that signal environment tile 128 encloses the initial estimated location. Accordingly, result set 212 of query 210 includes signal environment tile 128.

Mobile device 102 can determine, from the signal environment data, a signal environment category of the identified signal environment tile. The signal environment category can be associated with a list of one or more actions. The actions can include activating or deactivating a location subsystem of mobile device 102, setting one or more parameters of a location subsystem of mobile device 102, or requesting additional data for location determination.

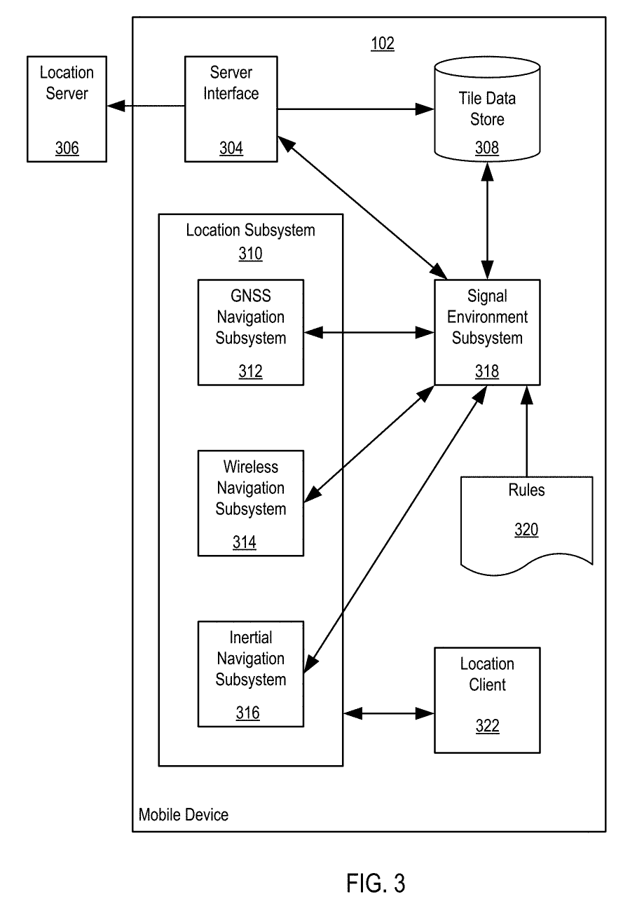

In the example shown, mobile device 102 determines that signal environment tile 128 is associated with a signal environment category designated as “urban canyon.” Accordingly, mobile device 102 can perform one or more actions associated with the “urban canyon” signal environment category. These actions can include, for example, activating wireless navigation subsystem 314 (FIG. 3) to aid GNSS navigation, setting parameters for GNSS navigation subsystem 312 (FIG. 3), fetching additional data to aid GNSS navigation, or various combinations of the above.

Upon activating wireless navigation subsystem 314, mobile device 102 can estimate an intermediate location (e.g., a location estimate with accuracy level of tens of meters) using the wireless navigation subsystem 314. Mobile device 102 can use the intermediate location to select only GNSS satellites that are above the horizon as viewed from the estimated intermediate location for scanning. Mobile device 102 can use the estimated intermediate location to confirm that a PVT solution from GNSS navigation subsystem 312 is correct (or incorrect). Mobile device 102 can use the intermediate location as a final location estimate if GNSS navigation subsystem 312 is unable to provide a PVT solution.

Setting parameters for GNSS navigation subsystem 312 to ones that are suitable for certain signal environments can include adjusting a coherent integration interval of a GNSS receiver. For example, mobile device 102 can increase the coherent integration interval for signal categories that indicate more interference (e.g., dense urban or urban canyon). Setting the parameters can include deactivating duty cycling of GNSS navigation subsystem 312, or reducing the “sleep” time in the duty cycling for signal categories that indicate more interference.

Obtaining additional data to aid GNSS navigation can include requesting terrain data for signal environment tile 128 from location server 214. Location server 214 can be the same as location server 106 (of FIG. 1) or a different location server. Location server 214 can include, or be coupled to, location feature database 216 that stores the terrain data. The terrain data can include three-dimensional (3D) building models. The 3D building models can specify reflective surfaces of physical structures that can reflect GNSS signals. The 3D building models can aid a GNSS navigation subsystem to determine which satellite signals are subject to reflection and multipath effect. The GNSS navigation subsystem can correct the multipath effect on such signals in PVT calculations. Techniques on correcting the multipath effect on GNSS signals are discussed in additional details in U.S. Publication 2015/0338522, titled “Positioning Using Non-Line-of Sight Signals” and U.S. Publication 2015/0341886, titled “Correcting Interference of Non-Line-of-Sight Signals,” the entire content of both of which is incorporated herein by reference.

In the example shown, location server 214 can provide 3D building model 218 for download. 3D building model 218 can include information on structures 220, 222 and 224 (e.g., high-rise buildings) that are located in signal environment tile 128. Mobile device 102 can then determine which of structures 220, 222 or 224 may block or reflect a signal from a GNSS satellite given a position of the GNSS satellite and an estimated position of mobile device 102. The knowledge on which satellite signal is blocked or reflected can help determine a lower bound of uncertainty in position estimation. Techniques on determining a lower bound of uncertainty in position estimation are discussed in addition details in U.S. patent application Ser. No. 14/848,234, titled “GNSS Positioning Using Three-Dimensional Building Models,” the entire content of which is incorporated herein by reference.

### Example Devices

FIG. 3 is a block diagram illustrating components of example mobile device 102 configured to use using signal environment data to aid positioning. Mobile device 102 can include server interface subsystem 304. Server interface subsystem 304 is a component of mobile device 102 configured to communicate with location server 306 to obtain data used in location estimation. Location server 306 can include location server 106 of FIG. 1, location sever 214 of FIG. 2, or both. The data used in location estimation can include signal environment data 104 of FIG. 1, terrain data including 3D building models as described in reference to FIG. 2, or both. Mobile device 102 can store the obtained data in tile data store 308.

Mobile device 102 can include location subsystem 310. Location subsystem 310 is a component of mobile device 102 configured to estimate a location of mobile device 102. Location subsystem 310 can include GNSS navigation subsystem 312 configured to estimate a location using GNSS signals. In some implementations, GNSS navigation subsystem 312 can include a GPS, GLONASS or Galileo receiver. Location subsystem 310 can include wireless navigation subsystem 314 configured to estimate a location using wireless access points (APs) of one or more wireless local area networks (WLANs). Location subsystem 310 can include inertial navigation subsystem 316 configured to estimate a location using magnetometer data and dead reckoning. Each of GNSS navigation subsystem 312, wireless navigation subsystem 314 and inertial navigation subsystem 316 can be individually configured and individually activated or deactivated.

Mobile device 102 can include signal environment subsystem 318. Signal environment subsystem 318 is a component of mobile device 102 configured to aid location estimation using signal environment data stored in tile data store 308. Signal environment subsystem 318 can receive an initial location estimate from location subsystem 310 (e.g., from GNSS navigation subsystem 312, wireless navigation subsystem 314 or inertial navigation subsystem 316). Signal environment subsystem 318 can determine a signal environment tile in which mobile device 102 is likely located, e.g., by performing a match. Signal environment subsystem 318 can determine a signal environment category of that signal environment tile. Signal environment subsystem 318 can determine a set of one or more rules 320 that correspond to that signal environment category.

Rules 320 can specify what action or actions to perform for that category. The actions can include setting parameters for GNSS navigation subsystem 312, wireless navigation subsystem 314, inertial navigation subsystem 316, or other location subsystems. For example, rules 320 can associate less duty cycling of the GNSS navigation subsystem 312 for signal environment categories indicating more interference on GNSS signals. Rules 320 can specify that in a signal environment category (e.g., a marine or rural category) where interference is in a degree designated as slight, duty cycling of GNSS navigation subsystem 312 shall be turned to a high level (e.g., 1 second on, 2 seconds off). Rules 320 can specify that in a signal environment category (e.g., an urban category) where interference is in a degree designated as moderate, duty cycling of GNSS navigation subsystem 312 shall be set to an intermediate level (e.g., 0.2 seconds on, 0.8 seconds off). Rules 320 can specify that in a signal environment category (e.g., a dense urban or urban canyon category) where interference is in a degree designated as strong, duty cycling of GNSS navigation subsystem 312 shall be deactivated.

The actions specified in rules 320 can include activating or deactivating one or more components of mobile device 102, e.g., one or more components of location subsystem 310. For example, rules 320 can activate more navigation subsystems to aid GNSS navigation subsystem 312 for signal environment categories indicating more interference on GNSS signals. Rules 320 can specify that for marine and rural categories, wireless navigation subsystem 314 and inertial navigation subsystem 316 shall be deactivated. Rules 320 can specify that for dense urban and urban canyon categories, wireless navigation subsystem 314 and inertial navigation subsystem 316 shall be activated.

The actions specified in rules 320 can include directing server interface subsystem 304 to request additional data (e.g., AP locations, terrain data including 3D building models, or both) for that signal environment tile from location server 306. Signal environment subsystem 318 can provide the additional signal environment data to one or more components of location subsystem 310 for location determination. In some implementations, rules 320 can specify that mobile device 102 shall request additional signal environment data only upon determining that mobile device 102 is in a pedestrian mode, where mobile device 102 moves at a velocity that is below a threshold value.

In some implementations, rules 320 can be stored in a look-up table or relational database. Table I below is an example look-up table.

TABLE I
Example Rule Look-up Table

| | Category | |
|---|---|---|
| Category | Name | Rules |
| 0 | Marine | Deactivate wireless navigation subsystem 314 |
| | | Deactivate inertial navigation subsystem 316 |
| | | Set duty-cycling of GNSS navigation subsystem |
| | | 312 to a first set of values designated as high |
| 1 | Rural | Deactivate wireless navigation subsystem 314 |
| | | Deactivate inertial navigation subsystem 316 |
| | | Set duty-cycling of GNSS navigation subsystem |
| | | 312 to a second set of values designated as high |
| 2 | Urban | Set wireless and inertial navigation subsystems |
| | | 314 and 316 to default operating mode |
| | | Set duty-cycling of GNSS navigation subsystem |
| | | 312 to a third set of values designated as default |
| 3 | Dense | Activate wireless navigation subsystem 314 |
| | Urban | Activate inertial navigation subsystem 316 |
| | | Set duty-cycling of GNSS navigation subsystem |
| | | 312 to a fourth set of values designated as low |
| 4 | Urban | Activate wireless navigation subsystem 314 |
| | Canyon | Activate inertial navigation subsystem 316 |
| | | Deactivate duty-cycling of GNSS navigation |
| | | subsystem 312 |
| | | Increase a coherent integration interval of GNSS |
| | | navigation subsystem 312 |
| | | Obtain terrain data including one or more 3D |
| | | building models |

Upon determining a final location using information from signal environment subsystem 318, location subsystem 310 can provide the final location to location client 322, which then provides the location to one or more application programs. For example, GNSS navigation subsystem 312 of location subsystem 310 can estimate a PVT solution. Location subsystem 310 can provide the estimated PVT solution to a daemon of location client 322, which can provide the estimated PVT solution to a fitness program or navigation program. The fitness program or navigation program can then present location information as, for example, current position, speed, distances traveled in a user interface of a device.

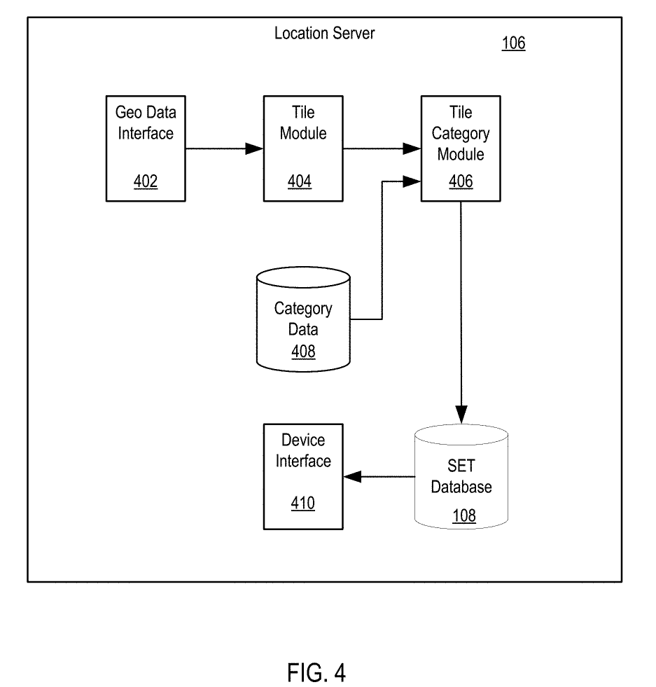

FIG. 4 is a block diagram illustrating components of example location server 106 providing signal environment data. Location server 106 can include geographic data interface 402. Geographic data interface 402 is a component of location server 106 configured to receive geographic data based on which signal environment data is derived. Geographic data interface 402 can include one or more components configured to receive data indicating wireless AP density (e.g., number of APs per square kilometer), digital surface models, 3D building models, geographic surveys, satellite imaging, population density, and other information that can indicate to what degree wireless navigation signals (e.g., GNSS signals) can be affected.

Location server 106 can include tile module 404. Tile module 404 is a component of location server 106 configured to divide and group data received from geographic data interface 402 into signal environment tiles. Tile module 404 can perform grouping based on a pre-specified or dynamically generated tile size and shape. Each signal environment tile can be defined by latitude and longitude coordinates. Tile module 404 can provide the grouped geographic data to signal environment category module 406.

Signal environment category module 406 is a component of location server 106 configured to associate a respective signal environment category with each signal environment tile. The signal environment categories can be pre-specified in category database 408. The signal environment categories can be numeric values or string values. The signal environment categories can be ordered according to degree of interference on navigation signals, and type of interference. For example, the signal environment categories can include category 0 (marine) where signals are not blocked but may be reflected, category 1 (rural) where signals are not blocked and not reflected, category 2 (urban) where there is a moderate degree of blockage and reflection of signals, category 3 (dense urban) where there is a high degree of blockage and reflection of signals, and category 4 (urban canyon) where there is severe blockage and reflection of signals. Other categories designating other characteristics of signal environments are possible.

Signal environment category module 406 can associate each signal environment tile with a respective signal environment category by determining whether geographic features in that signal environment tile satisfy one or more threshold values associated with that category. Signal environment category module 406 can then store the coordinates of the tiles and categories associated with the tiles in signal environment tile database 108 as signal environment data. Signal environment category module 406 can update the signal environment data upon receiving new data through geographic data interface 402. In some implementations, signal environment tile database 108 can store tiered signal environment data including, for example, 3D building models for “dense urban” or “urban canyon” categories of tiles.

Location server 106 can include device interface 410. Device interface 410 is a component of location server 106 configured to receive requests from mobile devices (e.g., mobile device 102). Device interface 410 can then provide the requested signal environment data or 3D building models in response.

### Example Procedures

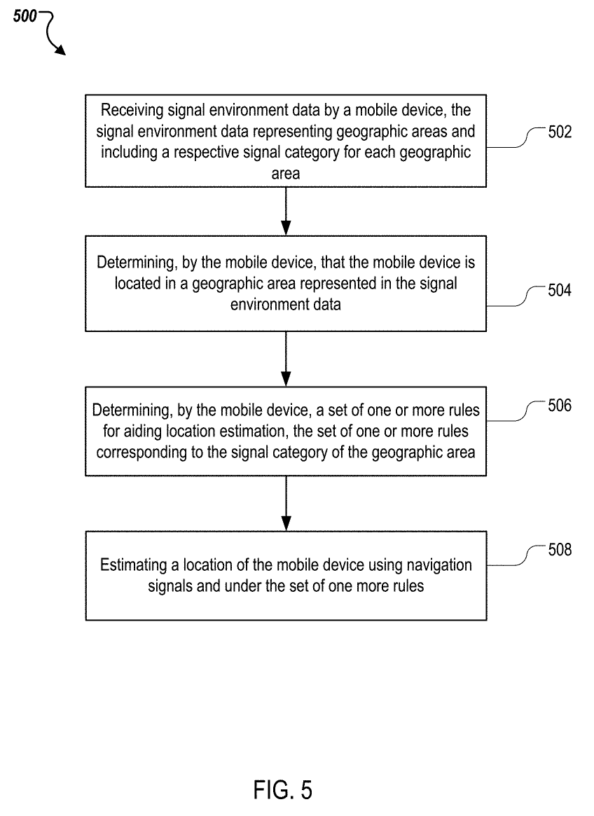

FIG. 5 is a flowchart of example process 500 of location estimation using signal environment data. Process 500 can be performed by mobile device 102.

Mobile device 102 can receive (502) signal environment data. The signal environment data can represent geographic areas, e.g., signal environment tiles as described in reference to FIG. 1. The signal environment data can include a respective signal environment category for each geographic area. Each signal environment category can correspond to one or more terrain attributes of the respective geographic area. Each signal environment category can correspond to a degree to which geographic features in the respective geographic area affect reception of the navigation signals. For example, a first signal environment category of a first geographic area can indicate that a signal environment of the first geographic area corresponds to a first degree of interference, a second signal environment category of a second geographic area can indicate that a signal environment of the second geographic area corresponds to a second degree of interference that is higher than the first degree of interference, where the signal environment of the second geographic area has more signal interferences (e.g., signal blockings, signal reflections or both) than the signal environment of the first geographic area has. Each signal environment category can indicate that the signal environment of the respective geographic area is a marine environment, a rural environment, an urban environment, a dense urban environment, or an urban canyon environment. The navigation signals can be GNSS signals. The signal environment data can be derived from at least one of wireless access point density, digital surface models, three-dimensional building models, geographic surveys or satellite imaging. A signal blocking can be an occurrence where a signal is blocked by an object. A signal reflection can be an occurrence where a signal is reflected by an object.

Mobile device 102 can determine (504), based at least in part on output from a location subsystem of mobile device 102, that mobile device 102 is located in a geographic area represented in the signal environment data. The location system can include at least one of a GNSS navigation subsystem, a wireless navigation subsystem, a cellular navigation subsystem, or an inertial navigation subsystem.

Mobile device 102 can determine (506) a set of one or more rules for aiding location estimation. The set of one or more rules can correspond to the signal environment category of the geographic area. The set of one or more rules can specify that for a signal environment indicated by at least one of the signal categories, an output from the wireless navigation subsystem shall be used to assist location estimation of the mobile device.

The set of one or more rules can specify that the wireless navigation subsystem and an inertial navigation subsystem be deactivated for a signal environment where buildings do not interfere with reception of the navigation signals, e.g., a signal environment designated as a rural environment. The set of one or more rules can specify that an inertial navigation subsystem be activated and duty cycling of the GNSS subsystem be deactivated for a signal environment where buildings interfere with reception of the navigation signals, e.g., signal environments designated as a dense urban or urban canyon environment. The set of one or more rules can specify that, for a signal environment where buildings interfere with reception of the navigation signals, e.g., signal environment designated as a dense urban environment or urban canyon environment, mobile device 102 shall request additional terrain data to aid navigation, the additional terrain data including a 3D terrain model (e.g., a 3D building model) of the geographic area.

Mobile device 102 can estimate (508) a location of mobile device 102 using the navigation signals and under the set of one more rules. Mobile device 102 can provide the estimated location as an input to an application program, or present the estimated location as an output on a user interface displayed on a surface of mobile device 102.

### Example Mobile Device Architecture

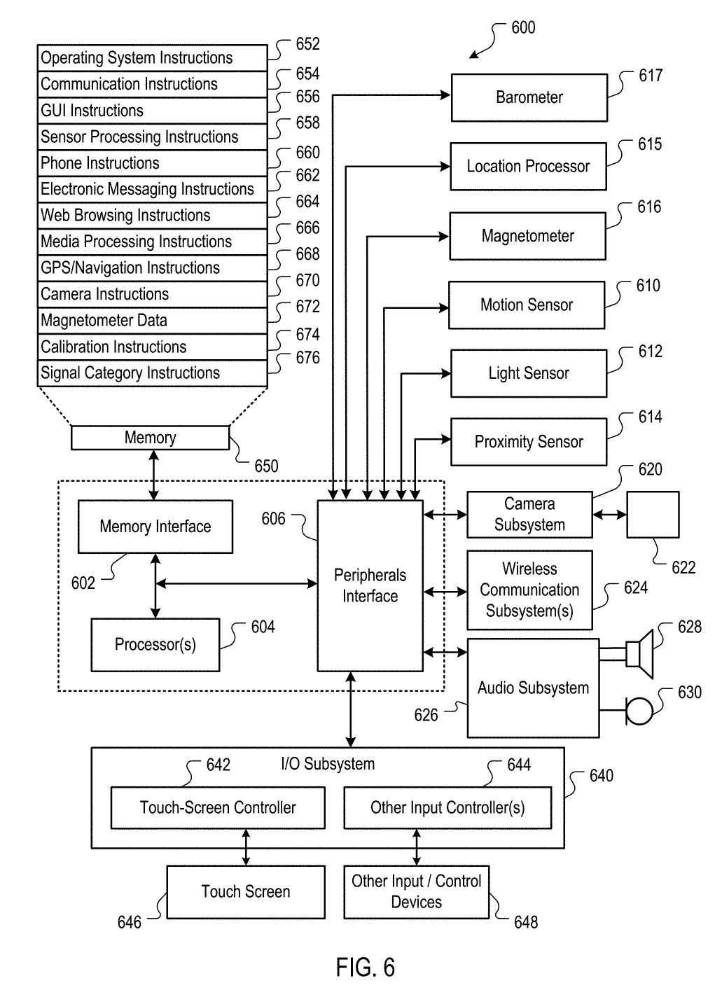

FIG. 6 is a block diagram of an example architecture 600 for a mobile device. A mobile device (e.g., mobile device 102) can include memory interface 602, one or more data processors, image processors and/or processors 604, and peripherals interface 606. Memory interface 602, one or more processors 604 and/or peripherals interface 606 can be separate components or can be integrated in one or more integrated circuits. Processors 604 can include application processors, baseband processors, and wireless processors. The various components in the mobile device, for example, can be coupled by one or more communication buses or signal lines.

Sensors, devices and subsystems can be coupled to peripherals interface 606 to facilitate multiple functionalities. For example, motion sensor 610, light sensor 612 and proximity sensor 614 can be coupled to peripherals interface 606 to facilitate orientation, lighting and proximity functions of the mobile device. Location processor 615 (e.g., GPS receiver) can be connected to peripherals interface 606 to provide geopositioning. Electronic magnetometer 616 (e.g., an integrated circuit chip) can also be connected to peripherals interface 606 to provide data that can be used to determine the direction of magnetic North. Thus, electronic magnetometer 616 can be used as an electronic compass. Motion sensor 610 can include one or more accelerometers configured to determine change of speed and direction of movement of the mobile device. Barometer 617 can include one or more devices connected to peripherals interface 606 and configured to measure pressure of atmosphere around the mobile device.

Camera subsystem 620 and an optical sensor 622, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 624, which can include radio frequency receivers and transmitters and/or optical (e.g., infrared) receivers and transmitters. The specific design and implementation of the communication subsystem 624 can depend on the communication network(s) over which a mobile device is intended to operate. For example, a mobile device can include communication subsystems 624 designed to operate over a GSM network, a GPRS network, an EDGE network, a Wi-Fi™ or WiMax™ network and a Bluetooth™ network. In particular, the wireless communication subsystems 624 can include hosting protocols such that the mobile device can be configured as a base station for other wireless devices.

Audio subsystem 626 can be coupled to a speaker 628 and a microphone 630 to facilitate voice-enabled functions, such as voice recognition, voice replication, digital recording, and telephony functions. Audio subsystem 626 can be configured to receive voice commands from the user.

I/O subsystem 640 can include touch surface controller 642 and/or other input controller(s) 644. Touch surface controller 642 can be coupled to a touch surface 646 or pad. Touch surface 646 and touch surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 646. Touch surface 646 can include, for example, a touch screen.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of speaker 628 and/or microphone 630.

In one implementation, a pressing of the button for a first duration may disengage a lock of the touch surface 646; and a pressing of the button for a second duration that is longer than the first duration may turn power to the mobile device on or off. The user may be able to customize a functionality of one or more of the buttons. The touch surface 646 can, for example, also be used to implement virtual or soft buttons and/or a keyboard.

In some implementations, the mobile device 102 can present recorded audio and/or video files, such as MP3, AAC, and MPEG files. In some implementations, the mobile device can include the functionality of an MP3 player. Other input/output and control devices can also be used.

Memory interface 602 can be coupled to memory 650. Memory 650 can include high-speed random access memory and/or non-volatile memory, such as one or more magnetic disk storage devices, one or more optical storage devices, and/or flash memory (e.g., NAND, NOR). Memory 650 can store operating system 652, such as Darwin, RTXC, LINUX, UNIX, OS X, WINDOWS, or an embedded operating system such as VxWorks. Operating system 652 may include instructions for handling basic system services and for performing hardware dependent tasks. In some implementations, operating system 652 can include a kernel (e.g., UNIX kernel).

Memory 650 may also store communication instructions 654 to facilitate communicating with one or more additional devices, one or more computers and/or one or more servers. Memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes and instructions; camera instructions 670 to facilitate camera-related processes and functions; magnetometer data 672 and calibration instructions 674 to facilitate magnetometer calibration. The memory 650 may also store other software instructions (not shown), such as security instructions, web video instructions to facilitate web video-related processes and functions, and/or web shopping instructions to facilitate web shopping-related processes and functions. In some implementations, the media processing instructions 666 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 650. Memory 650 can store signal environment instructions 676 that, when executed, can cause processor 604 to perform operations of example process 500 as described above in reference to FIG. 5.

Each of the above identified instructions and applications can correspond to a set of instructions for performing one or more functions described above. These instructions need not be implemented as separate software programs, procedures or modules. Memory 650 can include additional instructions or fewer instructions. Furthermore, various functions of the mobile device may be implemented in hardware and/or in software, including in one or more signal processing and/or application specific integrated circuits.

### Example Operating Environment

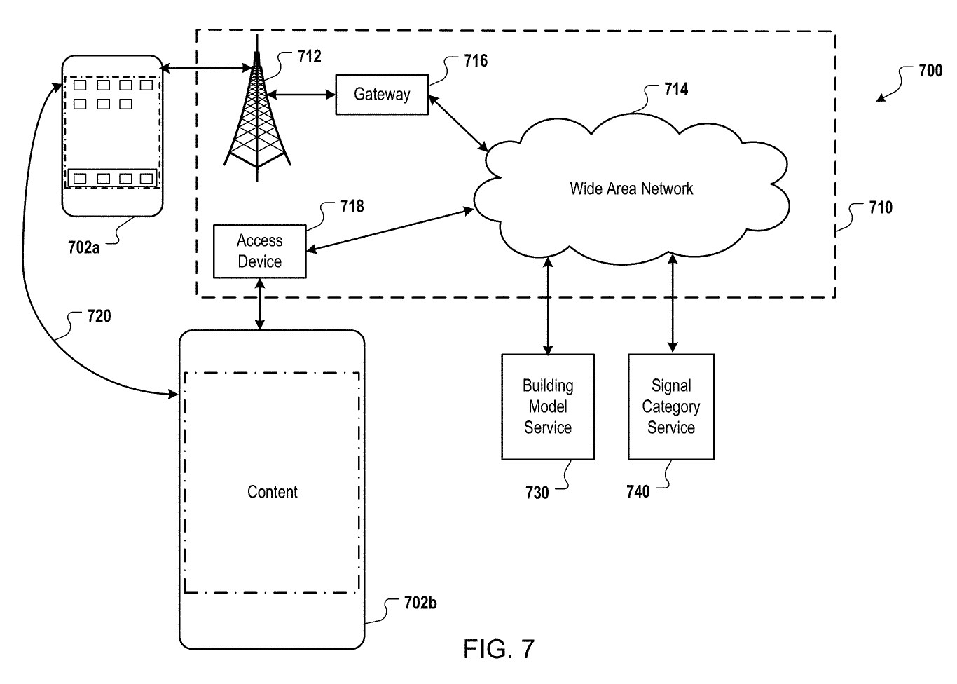

FIG. 7 is a block diagram of an example network operating environment 700 for the mobile devices of FIGS. 1-6. Mobile devices 702a and 702b can, for example, communicate over one or more wired and/or wireless networks 710 in data communication. For example, a wireless network 712, e.g., a cellular network, can communicate with a wide area network (WAN) 714, such as the Internet, by use of a gateway 716. Likewise, an access device 718, such as an 802.11g wireless access point, can provide communication access to the wide area network 714. Each of mobile devices 702a and 702b can be mobile device 102.

In some implementations, both voice and data communications can be established over wireless network 712 and the access device 718. For example, mobile device 702a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 712, gateway 716, and wide area network 714 (e.g., using Transmission Control Protocol/Internet Protocol (TCP/IP) or User Datagram Protocol (UDP)). Likewise, in some implementations, the mobile device 702b can place and receive phone calls, send and receive e-mail messages, and retrieve electronic documents over the access device 718 and the wide area network 714. In some implementations, mobile device 702a or 702b can be physically connected to the access device 718 using one or more cables and the access device 718 can be a personal computer. In this configuration, mobile device 702a or 702b can be referred to as a “tethered” device.

Mobile devices 702a and 702b can also establish communications by other means. For example, wireless device 702a can communicate with other wireless devices, e.g., other mobile devices, cell phones, etc., over the wireless network 712. Likewise, mobile devices 702a and 702b can establish peer-to-peer communications 720, e.g., a personal area network, by use of one or more communication subsystems, such as the Bluetooth™ communication devices. Other communication protocols and topologies can also be implemented.

The mobile device 702a or 702b can, for example, communicate with one or more services 730 and 740 over the one or more wired and/or wireless networks. For example, one or more building model services 730 can provide 3D building information for each signal environment tile to mobile devices 702a and 702b as requested by mobile devices 702a and 702b. Signal category service 740 can receive survey data from one or more survey devices, generate signal environment tiles, associate the tiles with signal categories, and provide the coordinates of the tiles and associated signal categories to mobile devices 702a and 702b as signal environment data.

Mobile device 702a or 702b can also access other data and content over the one or more wired and/or wireless networks. For example, content publishers, such as news sites, Really Simple Syndication (RSS) feeds, web sites, blogs, social networking sites, developer networks, etc., can be accessed by mobile device 702a or 702b. Such access can be provided by invocation of a web browsing function or application (e.g., a browser) in response to a user touching, for example, a Web object.

### Example System Architecture

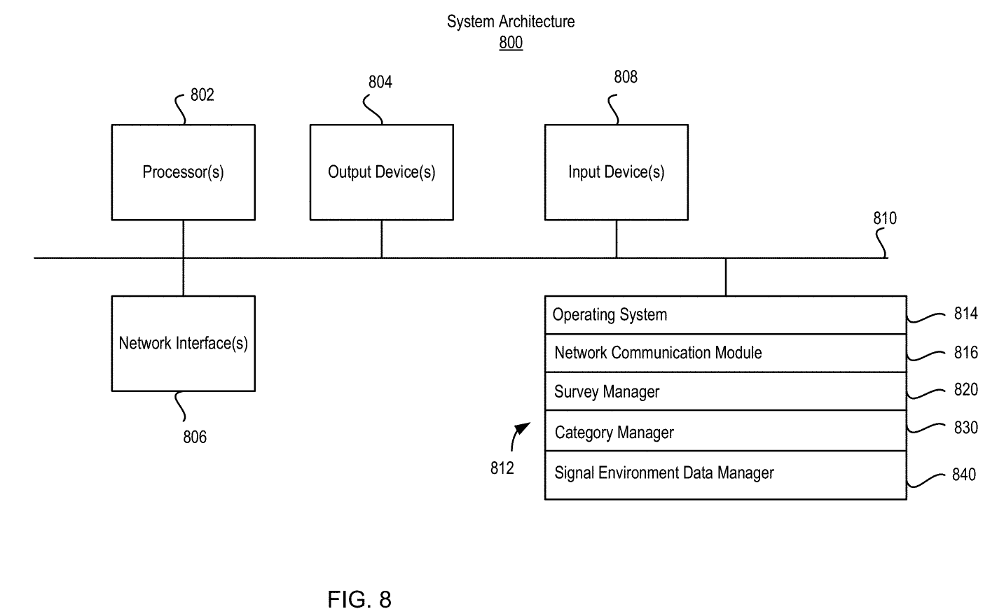

FIG. 8 is a block diagram of a system architecture 800 for example location server 106. Other architectures are possible, including architectures with more or fewer components. In some implementations, architecture 800 includes one or more processors 802 (e.g., dual-core Intel® Xeon® Processors), one or more output devices 804 (e.g., LCD), one or more network interfaces 806, one or more input devices 808 (e.g., mouse, keyboard, touch-sensitive display) and one or more computer-readable mediums 812 (e.g., RAM, ROM, SDRAM, hard disk, optical disk, flash memory, etc.). These components can exchange communications and data over one or more communication channels 810 (e.g., buses), which can utilize various hardware and software for facilitating the transfer of data and control signals between components.

The term “computer-readable medium” refers to a medium that participates in providing instructions to processor 802 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 812 can further include operating system 814 (e.g., a Linux® operating system), network communication module 816, survey manager 820, category manager 830 and signal environment data manager 840. Operating system 814 can be multi-user, multiprocessing, multitasking, multithreading, real time, etc. Operating system 814 performs basic tasks, including but not limited to: recognizing input from and providing output to network interfaces 806 and/or devices 808; keeping track and managing files and directories on computer-readable mediums 812 (e.g., memory or a storage device); controlling peripheral devices; and managing traffic on the one or more communication channels 810. Network communications module 816 includes various components for establishing and maintaining network connections (e.g., software for implementing communication protocols, such as TCP/IP, HTTP, etc.).

Survey manager 820 can include computer instructions that, when executed, cause processor 802 to receive survey data of geographic features. Category manager 830 can include computer instructions that, when executed, cause processor 802 to receive input that defines signal categories, or generate signal categories based on the survey data. Signal environment data manager 840 can include computer instructions that, when executed, cause processor 802 to perform operations of generating signal environment tiles using geographic information, assigning signal categories to the generated tiles to create signal environment data, and provide the signal environment data and other tile information to a mobile device upon request.

Architecture 800 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
receiving, by a mobile device, signal environment data, the signal environment data representing geographic areas and including a respective signal environment category for each geographic area, each signal environment category corresponding to a degree in which geographic features in the respective geographic area affect reception of global navigation satellite system (GNSS) signals;
determining, by the mobile device, that the mobile device is located in a geographic area represented in the signal environment data;
determining, by the mobile device, a set of one or more rules that aid location estimation of the mobile device, the set of one or more rules corresponding to the signal environment category of the geographic area; and
estimating a location of the mobile device using the GNSS signals and the set of one more rules.

2. The method of claim 1, wherein a first signal environment category of a first geographic area indicates that a signal environment of the first geographic area corresponds to a first degree of interference, a second signal environment category of a second geographic area indicates that a signal environment of the second geographic area corresponds to a second degree of interference that is higher than the first degree of interference, wherein the signal environment of the second geographic area has more signal interferences than the signal environment of the first geographic area has.

3. The method of claim 1, wherein the set of one or more rules specify that for a signal environment indicated by at least one of the signal categories, an output from a wireless navigation subsystem of the mobile device shall be used to assist location determination by a GNSS navigation subsystem of the mobile device.

4. The method of claim 1, wherein the set of one or more rules specify that a wireless navigation subsystem and an inertial navigation subsystem of the mobile device be deactivated for a signal environment where physical structures do not interfere with reception of the GNSS signals.

5. The method of claim 1, wherein the set of one or more rules specify that an inertial navigation subsystem of the mobile device be activated and duty cycling of a GNSS navigation subsystem of the mobile device be deactivated for a signal environment where physical structures interfere with reception of the navigation signals.

6. The method of claim 1, wherein the set of one or more rules specify that, for a signal environment where buildings interfere with reception of the GNSS signals, the mobile device shall request additional terrain data to aid navigation of the mobile device, the additional terrain data including a terrain model of the geographic area.

7. The method of claim 1, wherein the signal environment data is derived from wireless access point density.

8. A system comprising:
one or more processors; and
a non-transitory computer-readable medium storing instructions that, when executed by the one or more processors, cause the one or more processors to perform operations comprising:
receiving signal environment data, the signal environment data representing geographic areas and including a respective signal environment category for each geographic area, each signal environment category corresponding to a degree in which geographic features in the respective geographic area affect reception of global navigation satellite system (GNSS) signals;
determining that a mobile device is located in a geographic area represented in the signal environment data;
determining a set of one or more rules that aid location estimation of the mobile device, the set of one or more rules corresponding to the signal environment category of the geographic area; and
estimating a location of the mobile device using the GNSS signals and the set of one more rules.

9. The system of claim 8, wherein a first signal environment category of a first geographic area indicates that a signal environment of the first geographic area corresponds to a first degree of interference, a second signal environment category of a second geographic area indicates that a signal environment of the second geographic area corresponds to a second degree of interference that is higher than the first degree of interference, wherein the signal environment of the second geographic area has more signal interferences than the signal environment of the first geographic area has.

10. The system of claim 8, wherein the set of one or more rules specify that for a signal environment indicated by at least one of the signal categories, an output from a wireless navigation subsystem of the mobile device shall be used to assist location determination by a GNSS navigation subsystem of the mobile device.

11. The system of claim 8, wherein the set of one or more rules specify that a wireless navigation subsystem and an inertial navigation subsystem of the mobile device be deactivated for a signal environment where physical structures do not interfere with reception of the GNSS signals.

12. The system of claim 8, wherein the set of one or more rules specify that an inertial navigation subsystem of the mobile device be activated and duty cycling of a GNSS navigation subsystem of the mobile device be deactivated for a signal environment where physical structures interfere with reception of the navigation signals.

13. The system of claim 8, wherein the set of one or more rules specify that, for a signal environment where buildings interfere with reception of the GNSS signals, the mobile device shall request additional terrain data to aid navigation of the mobile device, the additional terrain data including a terrain model of the geographic area.

14. The system of claim 8, wherein the signal environment data is derived from wireless access point density.

15. A non-transitory computer-readable medium storing instructions that, when executed by one or more processors, cause the one or more processors of a mobile device to perform operations comprising:
receiving, by a mobile device, signal environment data, the signal environment data representing geographic areas and including a respective signal environment category for each geographic area, each signal environment category corresponding to a degree in which geographic features in the respective geographic area affect reception of global navigation satellite system (GNSS) signals;
determining, by the mobile device, that the mobile device is located in a geographic area represented in the signal environment data;
determining, by the mobile device, a set of one or more rules that aid location estimation of the mobile device, the set of one or more rules corresponding to the signal environment category of the geographic area; and
estimating a location of the mobile device using the GNSS signals and the set of one more rules.

16. The non-transitory computer-readable medium of claim 15, wherein a first signal environment category of a first geographic area indicates that a signal environment of the first geographic area corresponds to a first degree of interference, a second signal environment category of a second geographic area indicates that a signal environment of the second geographic area corresponds to a second degree of interference that is higher than the first degree of interference, wherein the signal environment of the second geographic area has more signal interferences than the signal environment of the first geographic area has.

17. The non-transitory computer-readable medium of claim 15, wherein the set of one or more rules specify that for a signal environment indicated by at least one of the signal categories, an output from a wireless navigation subsystem of the mobile device shall be used to assist location determination by a GNSS navigation subsystem of the mobile device.

18. The non-transitory computer-readable medium of claim 15, wherein the set of one or more rules specify that a wireless navigation subsystem and an inertial navigation subsystem of the mobile device be deactivated for a signal environment where physical structures do not interfere with reception of the GNSS signals.

19. The non-transitory computer-readable medium of claim 15, wherein the set of one or more rules specify that an inertial navigation subsystem of the mobile device be activated and duty cycling of a GNSS navigation subsystem of the mobile device be deactivated for a signal environment where physical structures interfere with reception of the navigation signals.

20. The non-transitory computer-readable medium of claim 15, wherein the set of one or more rules specify that, for a signal environment where buildings interfere with reception of the GNSS signals, the mobile device shall request additional terrain data to aid navigation of the mobile device, the additional terrain data including a terrain model of the geographic area.
